(19) United States
(12) Patent Application Publication
(10) Pub. No.: US 2021/0127584 A1
(43) Pub. Date: May 6, 2021

(54) ADJUSTABLE STOP FOR FEEDER HOUSE DRUM

(71) Applicant: AGCO do Brasil Soluções Agrícolas Ltda., Ribeirao Preto (BR)

(72) Inventors: Airton Solimar Walter, Nova Sant Rita (BR); Daniel Saraiva, Canoas (BR)

(21) Appl. No.: 16/879,259

(22) Filed: May 20, 2020

(30) Foreign Application Priority Data
Oct. 30, 2019 (GB) 1915736.1

(51) Int. Cl. A01F 12/10

(52) U.S. Cl. CPC A01F 12/10

(57) ABSTRACT

An agricultural harvesting machine includes a feederhouse having a conveyor and a feederhouse drum. An adjustable stop limits the position of the distance between slats of the conveyor and a floor of the feederhouse. The stop includes a member attached to the feederhouse drum and a spacer rotatably mounted on the member that co-operatively engages with a shaped portion of the member in at least two orientations in which rotation of the spacer is prevented. The spacer engages the feederhouse, and each orientation results in a different spacing of the member and the feederhouse drum relative to the feederhouse.

### CROSS-REFERENCE TO RELATED APPLICATION

This application claims the benefit of the filing date of U. K. Patent Application GB1915736.1, filed Oct. 30, 2019, the entire disclosure of which is incorporated herein by reference.

### FIELD

This disclosure relates generally to agricultural harvesting machines, such as combines and the like, and more particularly relates to an adjustable stop for a combine feederhouse drum.

### BACKGROUND

A feederhouse takes material from a cutting header and delivers it to a cylinder of a combine for subsequent threshing. To facilitate this, the feederhouse typically contains an endless chain-and-slat conveyor with cross slats that operate over the feederhouse floor.

When harvesting crops varying from small grain to corn, the feeding conditions vary. For small grain, the conveyor cross slats at the bottom of the drum should operate approximately one-eighth of an inch off the bottom wall of the feederhouse if all the crop material is to be conveyed effectively to the cylinder. However when harvesting corn, the material to be conveyed to the feederhouse is bulkier in comparison to small grain, and therefore an increase in the minimum clearance between the slats at the bottom of the drum and the feederhouse bottom wall is used to ensure improved feeding and to reduce damage to the more bulky crop material.

A front drum stop allows for the adjustment of the minimum distance between the slats of the conveyor and the feederhouse floor according to crop throughput or crop size. An adjustable stop is typically designed using bolts and nuts with tools being required to adjust the stop position accordingly.

An example of an adjustable stop for a feederhouse drum is disclosed in U.S. Pat. No. 3,699,753, “Quick-adjustable lower stop for feeder house drum,” granted Oct. 24, 1972, the entire disclosure of which is incorporated herein by reference. A wrench is used to adjust the position of such a stop.

### BRIEF SUMMARY

An improved adjustable stop suitable for a feederhouse drum does not require the use of any specific tools so as to allow the feederhouse drum to be quickly adjusted when moving from small grain to larger grain such as corn or vice versa.

In some embodiments, an agricultural harvesting machine comprises a feederhouse comprising a conveyor and a feederhouse drum; and a stop for limiting the position of the distance between slats of the conveyor and a floor of the feederhouse. The stop comprises a member attached to the feederhouse drum and a spacer rotatably mounted on the member which can co-operatively engage with a shaped portion of the member in at least two or more orientations in which rotation of the spacer is prevented. The spacer engages the feederhouse, and each orientation results in a different spacing of the member and the feederhouse drum relative to the feederhouse.

The agricultural harvesting machine may be a combine harvester.

The member may be tubular, cylindrical, or square. The member has a shaped portion providing an engaging section which co-operatively engages with the aperture of the spacer, which is shaped to receive and engage with the shaped portion of the member.

The shaped portion of the member may have a plurality of splines formed thereon or may have a plurality of longitudinal grooves formed in or on the outside surface of the shaped portion of the member. In an embodiment, the shaped portion of the member has at least 1, at least 2, at least 3, at least 4, at least 5, at least 6, or at least 7 splines formed on the outside surface of the shaped portion of the member; or at least 2, at least 3, at least 4, at least 5, at least 6, or at least 7 longitudinal grooves formed in or on the outside surface of the shaped portion of the member. Where multiple splines or grooves are provided, they may be of differing sizes. Some of the grooves or splines may prevent rotation whereas others define allowed positions to prevent inadvertent positioning errors.

In one embodiment, the shaped portion of the member has at least 1, at least 2, at least 3, at least 4, at least 5, at least 6, or at least 7 splines formed on the outside surface of the shaped portion, which can co-operatively engage with at least 2, at least 3, at least 4, at least 5, at least 6, or at least 7 longitudinal grooves longitudinal grooves formed on the inside surface of the aperture of the spacer.

In another embodiment, the shaped portion of the member has at least 2, at least 3, at least 4, at least 5, at least 6, or at least 7 longitudinal grooves formed in or on the outside surface of the shaped portion, which can co-operatively engage with at least 1, at least 2, at least 3, at least 4, at least 5, at least 6, or at least 7 splines formed on the inside surface of the aperture of the spacer.

In one embodiment, the member has one spline formed on the outside surface of the shaped portion of the member, which can co-operatively engage with at least one of two longitudinal grooves formed on the inside surface of the aperture of the spacer. The two longitudinal grooves formed on the inside surface of the aperture of the spacer correlate with the two orientations of the spacer, with one orientation allowing for an increase in the distance between the slats of the conveyor and a floor of the feederhouse for larger grain such as corn or where there is a high crop throughput. The other orientation of the spacer allows for a decrease in the distance between the slats of the conveyor and a floor of the feederhouse for smaller grain to be conveyed effectively.

In a further embodiment, the shaped portion of the member has 3 smaller splines and 4 larger splines or 3 smaller longitudinal grooves and 4 larger longitudinal grooves. This embodiment is illustrated in FIG. 3.

The member is attached to or mounted onto the outside of the front roller of the feeder conveyor, such as by bolts. The bolts are usually screwed to threaded bores which are present in a generally horizontal plate to which the feeder drum is rotatably attached.

The member may be attached to the feederhouse drum by a front drum arm.

The member may have a distal end at which there may be an optional annular groove followed by a ring, which may be splined and may act as a support to secure or retain the position of a spring connected to an anchor point on the external face of the feederhouse.

The member may have an aperture or radial bore to enable positioning of an optional shaft-locking pin therein.

The spacer can be formed to various shapes provided that the shape provides two different lateral dimensions (A and B in FIG. 2) of the spacer. In an embodiment, the spacer is rectangular in shape.

The spacer may define an aperture shaped to receive and co-operatively engage with the shaped portion of the member. The aperture may be cylindrical, tubular, square, etc.

The aperture of the spacer may be central to the spacer or offset from the center of the spacer. In an embodiment, the aperture of the spacer is central to the spacer.

The aperture may have at least 2, at least 3, at least 4, at least 5, at least 6, or at least 7 longitudinal grooves formed in/on the inner surface of the aperture, which align with at least 1, at least 2, at least 3, at least 4, at least 5, at least 6, or at least 7 splines formed on the outside surface of the shaped portion of the member.

In an alternative embodiment, the aperture may have at least 1, at least 2, at least 3, at least 4, at least 5, at least 6, or at least 7 splines formed on the inner surface of the aperture, which align with corresponding longitudinal grooves formed in or on the outside surface of the shaped portion of the member.

The spacer has a first lateral dimension (A) that differs from a second lateral dimension (B). This difference in lateral dimensions enables at least two locking positions of the space, which in combination with the splines either on the outside surface of the shaped portion of the member or the inner surface of the aperture of the spacer and the longitudinal grooves either on the outside surface of the shaped portion of the member or the inner surface of the aperture of the spacer, permit the stop position of the drum to be changed to change the distance between the slats of the conveyor and the floor of the feederhouse.

The area between the aperture of the spacer and the edges of the spacer may be solid or may have one or more cutaway sections. In a certain embodiment, the area between the aperture of the spacer and the edges of the spacer has at least 1 or more cutaway sections. In a further embodiment, the area between the aperture of the spacer and the edges of the spacer has at least 8 cutaway sections.

The spacer can move slidingly on the member. The member may have a section that does not form part of the shaped portion, which allows the spacer to be turned manually to change the orientation of the spacer.

The spacer may have a boss. The boss may be tubular or cylindrical. The boss may have at least 2 or at least 3 locking apertures arranged such that the optional shaft-locking pin can be inserted at a selected locking aperture to set the appropriate locking position of the spacer according to the crop type or crop throughput.

The bottom edge of the spacer engages the feederhouse resting on top of a shelf portion of the housing against which it is pulled down by a spring.

The shaft-locking pin may include a first tubular member formed from a single length of resilient wire-like material having first and second ends. The first end allows for insertion of the shaft-locking pin into the aperture or radial bore of the member. The second end has a spring to keep the first member of the shaft-locking pin in position.

The shaft-locking pin may include a second member formed from one or more straight lengths of flexible material, which terminate in a loop at each end of the straight lengths.

One of the advantages of the adjustable stop disclosed herein is that no wrench or specific tool is needed to adjust the stop position. Thus, adjustment of the feederhouse spacing may be a completely tool-less operation. In addition, the optional locking mechanism may be manually releasable, which can also be performed without tools.

The adjustment of the stop to change the position of the distance between the slats of the conveyor and the feederhouse floor may be performed as follows.

The optional shaft-locking pin is removed to allow the spacer to slide along the shaped portion of the member towards the direction of the spring to a section where there are no splines or longitudinal grooves. The spacer is then turned accordingly to a new position/orientation in accordance to the desired crop type or yield throughput. Once the new position or orientation is selected, the spacer is slid back along the member to engage with the shaped portion of the member.

The optional shaft-locking pin is inserted into the aperture or radial bore in the member to secure the position of the spacer by securing the first and second end of the first member of the shaft locking pin using the loops of the second member.

### BRIEF DESCRIPTION OF THE DRAWINGS

Further advantages will become apparent from reading the following description of specific embodiments with reference to the drawings, in which:

FIG. 1 is a schematic sectional view of a combine harvester.

FIG. 2 is an end view of a spacer 111 having an aperture 120 with longitudinal grooves formed on the inside surface of the aperture.

FIG. 3 is a perspective view of a member 110 having splines formed on the outside surface of a shaped portion of the member 111.

FIG. 4 is a perspective view of the spacer 111 in a first orientation and engaged with the shaped portion of the member 110.

FIG. 5 is a perspective view of the spacer 111 in the first orientation and engaged with the shaped portion of the member 110 and with a shaft-locking pin 112.

FIG. 6 is a perspective view of the spacer 111, member 110, and shaft-locking pin 112 in a second orientation.

FIG. 7 is a perspective view of the spacer 111, member 110, and shaft-locking pin 112 in the second orientation and engaged with a shelf 123 of a feederhouse.

### DETAILED DESCRIPTION

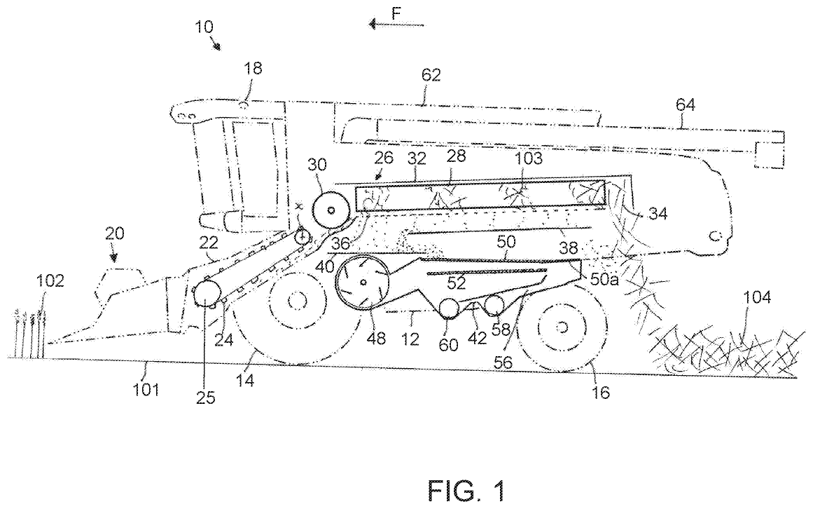

FIG. 1 illustrates in schematic form the main components of crop processing systems of a combine harvester 10. The crop processing system is shown in solid lines and the outline profile of harvester 10 is shown in ghost form. Thereafter, a specific embodiment will be described.

Combine harvester 10, hereinafter referred to as ‘combine,’ includes a frame 12 supported on front wheels 14 and rear steerable wheels 16 that engage the ground 101. A driver's cab 18 is also supported on the frame 12 and houses a driver's station from which a driver controls the combine 10.

A cutting header 20 is detachably supported on the front of a feederhouse 22 which is pivotable about a transverse axis x to lift and lower the header 20.

The combine 10 is driven in a forward direction (arrow F) across a field of standing crop 102. The header 20 cuts and gathers the standing crop 102 before conveying such as a crop material stream into a feederhouse 22.

A conveyor 24, which may be in the form of a chain-and-slat conveyor, is housed within the feederhouse 22 and operates to convey the crop material stream upwardly and rearwardly from the header 20 to a crop processor 26.

A front feederhouse drum 25 floats vertically, although stops are provided to maintain a small clearance between slats of the conveyor 24 and the feederhouse floor below the drum 25. As the crop material stream moves through the opening of the feederhouse 22, it is pulled under the drum 25 by the slats and moved upwardly and rearwardly along the feederhouse floor below the drum 25. The drum 25 is typically biased downward by a spring.

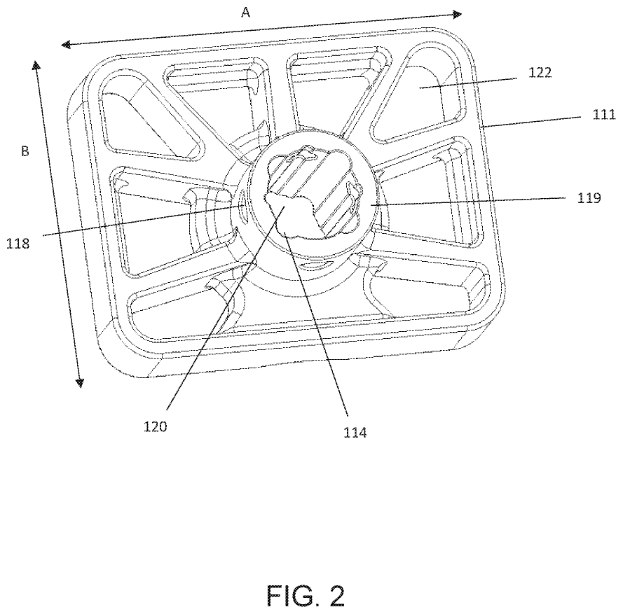

An adjustable stop enables the feederhouse drum 25 to be quickly adjusted by changing the position of the slats of the conveyor 24 relative and a floor of the feederhouse 22 when moving from smaller grain to larger grain and vice versa. Example embodiments will now be described with reference to FIGS. 2-7.

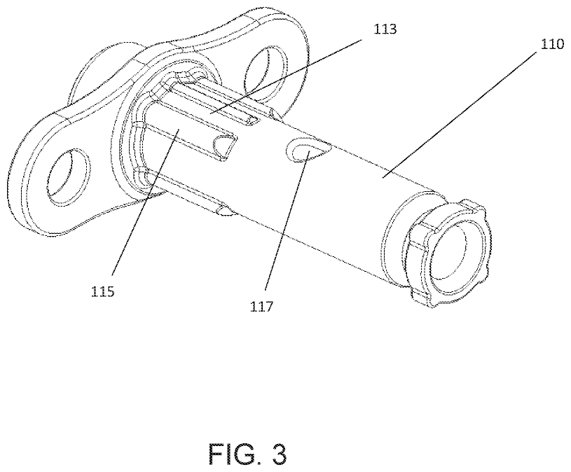

FIG. 2 shows a spacer 111 having a first lateral dimension (A) and a different second lateral dimension (B). This difference in lateral dimension enables the spacer to be used in at least two spacer orientations or locking positions, which in combination with splines either on an outside surface of a shaped portion of a member 110 (see FIG. 3 and discussion below) or an inner surface of an aperture of the spacer 111 and longitudinal grooves either on the outside surface of the shaped portion of the member or the inner surface of the aperture of the spacer 111, permit the stop position of the drum 25 to be changed to adjust the distance between slats of the conveyor 24 and a floor of the feederhouse 22.

In an embodiment, the spacer 111 as shown in FIG. 2 has eight cutaway sections 122 to reduce the weight of the spacer 111 without sacrificing physical properties.

The spacer 111 in FIG. 2 has an aperture 120 with 7 longitudinal grooves 114 formed on the inside surface of the aperture 120. Four of the longitudinal grooves 114 are larger so as to prevent rotation of the spacer and the other 3 smaller longitudinal grooves define allowed positions to prevent inadvertent positioning errors. The aperture 120 of the spacer 111 is configured to receive and co-operatively engage with the shaped portion of the member, which has 7 corresponding splines formed on the outside surface of the shaped portion of the member.

FIG. 3 shows a member 110 that can be attached to the outside of a front roller of the feeder conveyor 24, such as by bolts. The member 110 has a shaped portion 113 structured for engagement with the aperture 120 of the spacer 111, which has corresponding longitudinal grooves 114 that align with splines 115 formed on the outside surface of the shaped portion 113 of the member 110. As shown in FIG. 3, the shaped portion of the member 110 may have four larger splines and three smaller splines, which can engage or align with the corresponding four larger longitudinal grooves and three smaller grooves formed on the inside surface of the aperture 120 of the spacer 111.

Four of the longitudinal grooves 114 on the inside surface of the aperture 120 of the spacer 111 are larger to prevent rotation of the spacer 111, whereas the other three smaller longitudinal grooves 114 prevent inadvertent positioning of the spacer 111.

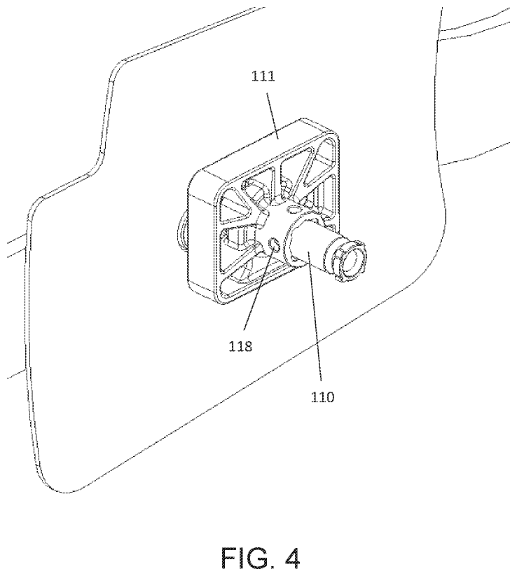

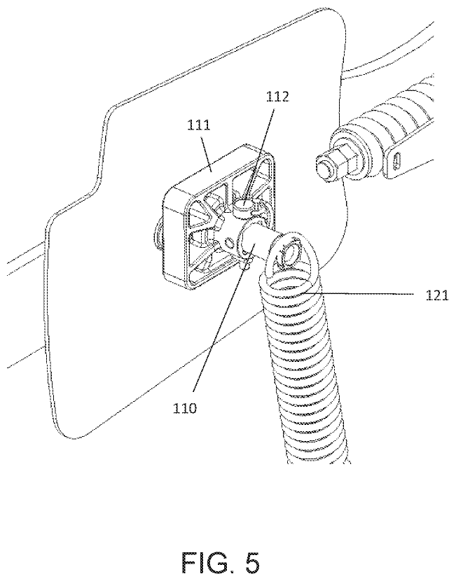

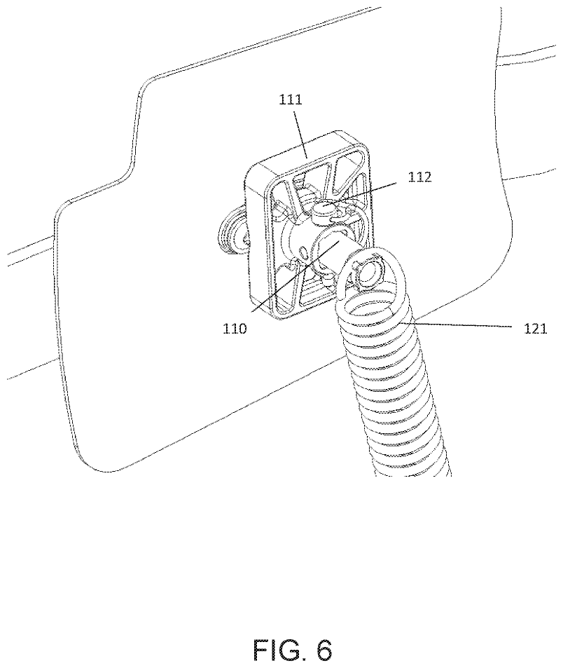

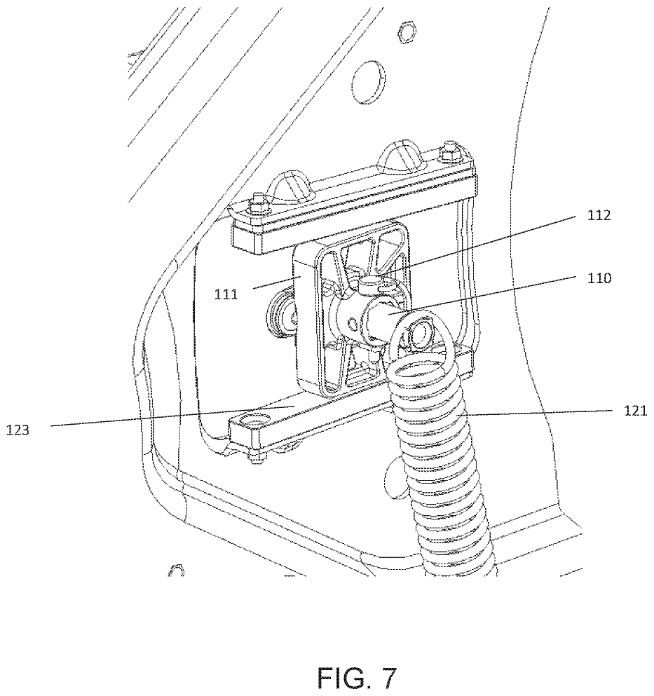

FIGS. 4 and 5 show the engagement of the shaped portion 113 of the member 110 with the aperture 120 of the spacer 111 in a first orientation of the spacer 111. FIGS. 6 and 7 show the engagement of the shaped portion 113 of the member 110 with the aperture 120 of the spacer 111 in a second orientation of the spacer 111. As shown in FIG. 7, the bottom edge of the spacer 111 engages the feederhouse 22, resting on top of a shelf portion 123 of the housing against which it is pulled down by a spring 121. In the first orientation of the spacer 111 as shown in FIGS. 4 and 5, the distance between the slats of the conveyor 24 and a floor of the feederhouse 22 is decreased such that smaller grain can be conveyed effectively. This is due to the spacer 111 having a smaller lateral dimension (B), which is perpendicular to a shelf portion 123 mounted onto the feederhouse 22 when the spacer 111 is in the first orientation, which means the distance from the center of the member 110 to the shelf portion 123 is smaller than the distance from the center of the member 110 to the shelf portion 123 when the spacer 111 is in its second orientation (i.e., the orientation of FIGS. 6 and 7, in which the larger lateral dimension (A) is perpendicular to the shelf portion 123 mounted onto the feederhouse 22). The distal end of the member 110 is pulled down by the spring 121, which rests on an annular groove.

When larger grain such as corn is to be conveyed effectively or when there is a high throughput, the position of the spacer 111 can be altered manually to the second orientation or locking position as shown in FIGS. 6 and 7. This is achieved by removing an optional shaft-locking pin 112 to allow the spacer 111 to slide along the shaped portion of the member 110 towards the direction of the spring 121. If no shaft-locking pin 112 is present, the spacer 111 slides along the portion of the member 110 towards the direction of the spring 121 to a section which has no splines or longitudinal grooves. The spacer 111 is then turned accordingly to a second locking position, which corresponds to a second orientation of the spacer 111. The spacer 111 is then slid back along the member 110 to allow for engagement of the aperture 120 of the spacer 111, which has longitudinal grooves 114 in or on the inside surface of the aperture 120 corresponding to the splines 115 formed on the outside surface of the shaped portion 113 of the member 110. The optional shaft-locking pin 112 is inserted into a locking aperture 118 of a boss 119 of the spacer 111 and into an aperture 117 in the member 110 to secure the position of the spacer 111 in the second locking position. In this second orientation of the spacer 111 or second locking position, the distance between the slats and the feederhouse floor below the drum 25 is increased so that larger grain such as corn can be conveyed without risk of damage. The second orientation of the spacer 111 or second locking position can also be used for when there is high throughput of crop.

As shown in FIG. 7, the bottom edge of the spacer 111 engages the feederhouse 22, resting on top of the shelf portion 123 of the housing against which it is pulled down by the spring 121. In the second orientation of the spacer 111 as shown in FIG. 7, the spacer 111 has a larger lateral dimension (A) perpendicular to the shelf portion 123 attached to the feederhouse 22, which means the distance of the center of the member 110 to the shelf portion 123 is greater than the distance of the center of the member 110 to the shelf portion 123 when the spacer 111 is in the first orientation. The distal end of the member 110 is pulled down by the spring 121, which rests on an annular groove.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventor. Further, embodiments of the disclosure have utility with different and various machine types and configurations

1. A feederhouse for an agricultural harvesting machine, the feederhouse comprising:
a feederhouse body comprising a floor;
a conveyor comprising a plurality of slats;
a feederhouse drum configured to drive the conveyor along the floor of the feederhouse body;
an adjustable stop configured to limit a distance between the slats of the conveyor and the floor of the feederhouse, wherein the stop comprises:
a member attached to the feederhouse drum; and
a spacer rotatably mounted on the member for co-operatively engaging with a shaped portion of the member in at least two different orientations in which rotation of the spacer is prevented, wherein the spacer is configured to engage the feederhouse body and wherein each of the at least two different orientation results in a different distance from the member and the feederhouse drum to the feederhouse floor.

2. The feederhouse of claim 1, wherein the shaped portion of the member defines at least one spline formed on an outside surface thereof.

3. The feederhouse of claim 1, wherein the member has a shape selected from the group consisting of tubular, cylindrical, and square.

4. The feederhouse of claim 1, wherein the shaped portion of the member has at least two longitudinal grooves formed on an outside surface thereof.

5. The feederhouse of claim 1, wherein the member defines an annular groove followed by a ring, wherein the groove is operable to retain a position of a spring connected to an anchor point on an external face of the feederhouse.

6. The feederhouse of claim 1, wherein the member is fixedly attached to an outside of a front roller of a feeder conveyor.

7. The feederhouse of claim 6, wherein the member is fixedly attached to the outside of the front roller by bolts.

8. The feederhouse of claim 1, wherein the member defines an aperture configured to receive a shaft-locking pin.

9. The feederhouse of claim 1, wherein a bottom edge of the spacer rests on top of a shelf portion of the feederhouse body.

10. The feederhouse of claim 9, further comprising a spring operable to bias the bottom edge of the spacer against the shelf portion of the feederhouse body.

11. The feederhouse of claim 9, wherein the spacer defines an aperture shaped to receive and co-operatively engage with the shaped portion of the member and the aperture has at least one spline formed on an inner surface of the aperture.

12. The feederhouse of claim 9, wherein the spacer defines an aperture which is shaped to receive and co-operatively engage with the shaped portion of the member and the aperture has at least two longitudinal grooves formed on an inner surface of the aperture.

13. The feederhouse of claim 1, wherein the spacer defines an aperture shaped to receive and co-operatively engage with the shaped portion of the member.

14. The feederhouse of claim 13, wherein the aperture has at least one spline formed on an inner surface of the aperture.

15. The feederhouse of claim 13, wherein the aperture has at least two longitudinal grooves formed on an inner surface of the aperture.

16. The feederhouse of claim 1, wherein the spacer has a boss.

17. The feederhouse of claim 14, wherein the boss has at least two locking apertures.

18. The feederhouse of claim 1, wherein the conveyor comprises a chain-and-slat conveyor.

19. An agricultural machine comprising the feederhouse of claim 1.

20. The agricultural machine of claim 18, wherein the feederhouse is configured to detachably support a cutting header.
